(19) United States
(12) Patent Application Publication
(10) Pub. No.: US 2022/0036847 A1
(43) Pub. Date: Feb. 3, 2022

(54) CIRCUIT FOR DRIVING GATE, DISPLAY MODULE, AND DISPLAY DEVICE

(71) Applicants: BEIHAI HKC OPTOELECTRONICS TECHNOLOGY CO., LTD., Beihai (CN); HKC CORPORATION LIMITED, Shenzhen (CN)

(72) Inventors: Chiayang Cheng, Beihai (CN); Lidan Ye, Beihai (CN)

(21) Appl. No.: 17/201,685

(22) Filed: Mar. 15, 2021

(30) Foreign Application Priority Data
Jul. 28, 2020 (CN) 202010735669.0

(51) Int. Cl. G09G 3/36

(52) U.S. Cl. CPC G09G 3/3677; G09G 2310/0272; G09G 2300/0439; G09G 3/3688

(57) ABSTRACT

Provided are circuit for gate driving, a display module and a display device. The circuit includes N row-driving circuits arranged in cascade on an array substrate, which are to output the Nth gate driving signal when the signal input end receives the signal for gate driving output by the (N−1)th row-driving circuit, and to control the sub pixels at the Nth row to charge. An Nth auxiliary circuit receives the (N−1)th gate driving signal at the input end, its controlled end is connected with the pull-up control signal end of the Nth row-driving circuit, and its output end is connected with the output end for gate driving signal, the Nth auxiliary circuit is configured to charge the sub pixels at the Nth row, in response that both the (N−1)th gate driving signal from the input end and the (N−1)th pull-up control signal from the controlled end are at high level.

### CROSS REFERENCE TO RELATED APPLICATIONS

The present application claims the priority of Chinese Patent Application filed in the National Intellectual Property Administration on Jul. 28, 2020, with the application number 202010735669.0 and Title “Circuit for driving gate, display module, and display device”, the entire contents of which are hereby incorporated by reference.

### TECHNICAL FIELD

The present disclosure relates to the technical field of liquid crystal display, in particular to a circuit for gate driving, a display module and a display device.

### BACKGROUND

In order to cater to the trends of LCD television with a larger size and a higher resolution, an increasing number of LCD panels resolves using a narrow frame design. The circuit for gate driving is generally arranged at the side frame of a display panel, and equal resistance can not be sett or wired between each scanning line and the gate driver, and uneven charging is easy to occur.

The aforementioned is assistant in understanding the technical solution of the present application, and does not necessarily admit that the aforementioned constitutes the prior art.

### SUMMARY

The present disclosure provides a circuit for gate driving, which includes:

N row-driving circuits arranged in cascade on an array substrate, wherein each row-driving circuit comprises a signal input end, a pull-up control signal end and an output end for gate driving signal; the Nth row-driving circuit is configured to output an Nth gate driving signal in response that the signal input end receives the gate driving signal output by the (N−1)th row-driving circuit, and to control the Nth sub pixel to charge;

N auxiliary circuits, wherein each auxiliary circuit is arranged corresponding to a row-driving circuit on the array substrate, and each auxiliary circuit comprises an input end, a controlled end and an output end, wherein

an Nth auxiliary circuit receives the (N−1)th gate driving signal at the input end, the controlled end of the Nth auxiliary circuit is connected with the pull-up control signal end of the Nth row-driving circuit, and the output end of the Nth auxiliary circuit is connected with the output end for gate driving signal,

the Nth auxiliary circuit is configured to control the sub pixels at the Nth row to charge, in response that both the (N−1)th gate driving signal from the input end and the (N−1)th pull-up control signal from the controlled end are at high level, wherein N [symbol] 2.

In one embodiment, wherein each auxiliary circuit includes a first active switch, a controlled end of the first active switch is the controlled end of the auxiliary circuit, an input end of the first active switch is the input end of the auxiliary circuit, and the output end of the first active switch is the output end of the auxiliary circuit.

In one embodiment, each row-driving circuit includes a charge circuit, a reset circuit and an output circuit, in which an input end of the charge circuit is the input end of the row-driving circuit, an output end of the charging circuit is the pull-up control signal end of the row-driving circuit and is connected with a controlled end of the output circuit, the input end of the output circuit receives a current timing signal, and the row-driving circuit outputs the gate driving signal at the output end of the output circuit.

The disclosure further provides a display module, which includes:

a display panel, and a circuit for gate driving described above, wherein the circuit includes N row-driving circuits arranged in cascade and auxiliary circuits arranged corresponding to each row-driving circuit, the N row-driving circuits and N auxiliary circuits are arranged at a side of the display panel.

In one embodiment, the display panel has a first side and a second side which are oppositely arranged;

N row-driving circuits and N auxiliary circuits are arranged on the first and second sides of the display panel.

In one embodiment, the display panel includes:

a pixel array comprising a plurality of sub-pixels at odd-numbered rows and a plurality of sub-pixels at even-numbered rows, wherein

the sub-pixels at each odd-numbered row is connected with an row-driving circuit arranged on the first side, and the sub-pixels at each odd-numbered row is connected with an auxiliary circuit arranged on the second side,

the sub-pixels of each even-numbered row are connected with an row-driving circuit arranged on the second side, and the sub-pixels of each even-numbered row are connected with an auxiliary circuit arranged on the first side.

In one embodiment, the display panel has a first side and a second side which are oppositely arranged;

the N row-driving circuits are all arranged on the first side of the display panel, and

the N auxiliary circuits are all arranged on the second side of the display panel.

In one embodiment, the display panel includes:

a pixel array comprising a plurality of sub-pixels in N rows, wherein

sub pixels in each row are connected with a row-driving circuit and an auxiliary circuit on the array substrate.

In one embodiment, the display module further includes a source driver and a plurality of data lines. A plurality of output ends of the source driver are connected with the pixel array of the display panel through the plurality of data lines.

The present disclosure also provides a display device, which includes the circuit for gate driving or the display module described above.

By N row-driving circuits in cascade and auxiliary circuits corresponding to each of the row-driving circuits, Nth signal for gate driving is output when the input end of the Nth row-driving circuit receives the row-driving signal output from the (N−1)th row-driving circuit. That is, when N−1 signal for gate driving received by the input end of the auxiliary circuit, and N−1 pull-up control signal received by the controlled end of the auxiliary circuit are both at high levels, the circuit for gate driving at Nth is controlled for the sub pixels at the Nth row to charge, and for the Nth circuit for gate driving to charge on the array substrate. The present disclosure charges a sub pixel at a same level simultaneously by the N auxiliary circuits and N row-driving circuits in cascade on the array substrate. The present disclosure compensates the non-fully charged sub pixels induced by a long wiring of the gate driving signal output from previous row-driving circuit to reach the next circuit. This problem is further induced by even wiring between the sub pixels at the adjacent end and at the distant end. And it is also induced by that multiple row-driving circuits on the array substrate are arranged at two sides of the display panel. The waveform of the gate driving signal is designed by the N row-driving circuits and the N auxiliary circuits, to ensure that each sub pixel at each row is charged to saturation, which is beneficial to the same charging effect and consistent brightness of each sub pixel. The present disclosure resolves the difference in charging saturation among sub-pixels or the pour saturation of the whole display panel. The unintended gray scale and dark lines have been solved, and the picture quality of the display device has improved.

### BRIEF DESCRIPTION OF THE DRAWINGS

In order to explain the embodiment of the present application or the technical solution of the related art more clearly, the following will briefly introduce the drawings necessary in the description of the embodiments or the related art. Obviously, the drawings in the following description are only some embodiments of the present application. For those ordinary skill in the art, other drawings can be obtained according to the structure shown in these drawings without any creative effort.

FIG. 1 is a schematic diagram showing functional modules, applied to a display module, of a circuit for gate driving according to an embodiment of the present disclosure.

FIG. 2 is a schematic diagram showing an electric connection, applied to a display module in a circuit for gate driving according to an embodiment of the present disclosure.

FIG. 3 is a schematic diagram showing an electric connection in a row-driving circuit in a circuit for gate driving according to an embodiment of the present disclosure.

FIG. 4 is a schematic diagram showing an electric connection in an auxiliary circuit in a circuit for gate driving according to an embodiment of the present disclosure.

FIG. 5 is a schematic diagram of a display module according to an embodiment of the present disclosure.

FIG. 6 is a schematic diagram of a display panel according to an embodiment of the present disclosure.

FIG. 7 is a schematic diagram showing a display module according to an embodiment of the present disclosure.

FIG. 8 is a timing diagram of a circuit for gate driving according to an embodiment of the present disclosure.

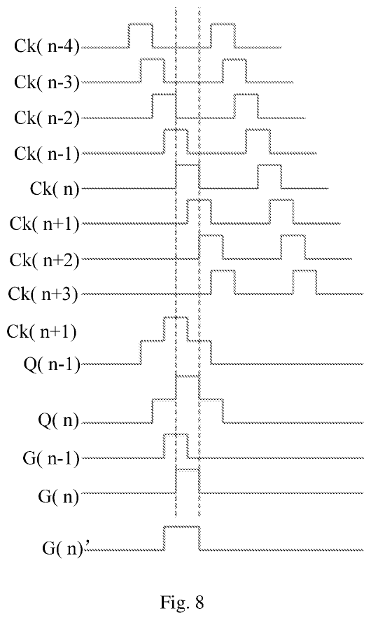

The implementation, functional characteristics and advantages of the present application will be further described with reference to the attached drawings in combination with embodiments.

### DETAILED DESCRIPTION OF THE EMBODIMENTS

As following, the technical solution in the embodiments of the present disclosure will be described clearly and completely with reference to the drawings in the embodiment of the present application. Obviously, the described embodiment is only a part of the embodiment of the present application, not all of the embodiments. Based on the embodiments in the present application, all other embodiments perceived by those ordinary skills in the art without creative effort should be fallen within the protection scope of the present application.

It should be noted that if directional indications (such as up, down, left, right, front, back, etc.) are involved in the embodiments of the present application, the directional indications are only used to explain the relative positional relationship and movement between the components in a certain posture (as shown in the drawings), and if the specific posture changes, the directional indications will change accordingly.

In addition, if there are descriptions of “first” and “second” in the embodiments of this application, the descriptions of “first” and “second” are used for descriptive purposes only and cannot be understood as indicating or implying their relative importance or implicitly indicating the number of indicated technical features. Thus, features defining “first” and “second” may explicitly or implicitly include at least one of the features. In addition, the technical solutions between the various embodiments may be combined with each other, but must be based on what one of ordinary skill in the art can achieve. When the combination of technical solutions is contradictory or impossible to achieve, it should be considered that the combination of such technical solutions does not exist and is not within the protection scope required by the present application.

The present disclosure provides a circuit for gate driving, which is applied to display devices with display panels such as mobile phones, computers and televisions.

According to Gate driver design, the display panel can be grouped into SOC (System on chip) and GOA (Gate driver on array). GOA, as a technology which directly makes the Gate driver IC on the array substrate of a display device, is a process technology that replaces the driver chip made of external silicon chip. The technology can reduce the production process and process cost, and improve the integration of display panel. With the development to a larger size and higher resolution of LCD television and computers, increasing LCD panels are designed having narrow frame to increase the display area of the screen.

GOA is generally arranged at the side frame of the display panel. the gate line scanning driving signal circuit is fabricated on the array substrate of the display panel by using Thin Film Transistor (TFT) liquid crystal display array process to drive and scan the gate lines row by row. It reduces production cost and realizes the narrow frame design, and is applied in various displays. In the exemplary architecture of the GOA display panel, LC (Liquid Crystal) molecules are filled between the upper and lower glass substrates and the periphery is sealed with sealing materials. Liquid crystal is a kind of polymer material, which has been widely used in thin and light display technology because of its special physical, chemical and optical characteristics.

According to the different sizes of the display panel, the GOA circuit can be arranged on one side or both sides of the display panel. When it is arranged on both sides of the display panel, the GOA circuits on both sides can simultaneously drive sub-pixels in one row to be conducted, or alternately control sub-pixels in each row to be conducted.

In some large-sized display panels, the resistance of scanning lines in the area far away from the gate drive and the area near the gate drive is uneven. Near the TFT array at the gate driver, the scanning lines are wired shorter, while far away from the side edge, that is, at the gate driver, the scanning lines are wired longer. According to the calculation, R= [symbol] L/S, it can be known that with the same cross-sectional area, the longer the length of the traces, the larger the resistance, and vice versa. wherein R represents the resistance value, S represents the cross-sectional area of the traces, L represents the length of the traces, and [symbol] represents the resistivity of the traces. Sub-pixels in the same row are turned on simultaneously, and the output time of data signals to each sub-pixel is identical, which would definitely lead to uneven brightness of the display panel due to uneven charging between driving the sub pixels away from the gate and driving sub pixels near the gate. Therefore, gate driver are often provided on the left and right sides of the display panel. And GOA driving signals such as frame Start Vertical (STV), Clock Pulse Vertical (CPV), clock signals CK1˜CKx and low frequency signals LC1&LC2 are output through the timing controller, and transmitted to the GOA circuits on the left and right sides of the panel. After the GOA circuits operate normally, the scanning lines gate line in the display panel 20 are turned on line by line to realize bilateral driving.

In some relatively small-sized display panels, the GOA circuits arranged on opposite sides of the display panel can alternately control each row of sub-pixels to be conducted. For example, the GOA circuit arranged on one side of the display panel controls the sub-pixels of odd-numbered rows to be conducted, while the GOA circuit arranged on the other side of the display panel controls the sub-pixels of even-numbered rows to be conducted so as to realize single driving in a staggered way. Or the GOA circuit arranged on one side of the display panel controls the sub-pixels to be conducted line by line to realize unilateral driving. Because the GOA circuit is arranged at the side frame of the display panel, the brightness of the display area near the gate driver is greater than that far away from the gate driver, which leads to uneven brightness between the areas far away from the gate driver (hereinafter referred to as the distant end) and the areas near the gate driver (hereinafter referred to as the adjacent end) due to the uneven charging discussed above. In addition, the output signal (gate opening signal) is not only configured to output and drive the sub pixels in the current row in GOA circuits, but also serves as the reset signal for the previous row and the input signal of the next row. Therefore, in staggered single driving, the reset signal for the previous row and the input signal for the next row in the GOA circuits are on the opposite side of the display panel. This may need to lay long traces, easily reducing the charging efficiency of the display panel.

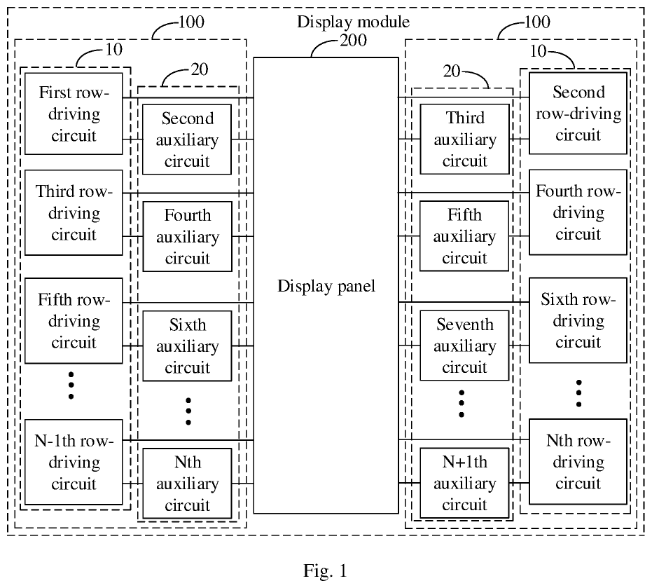

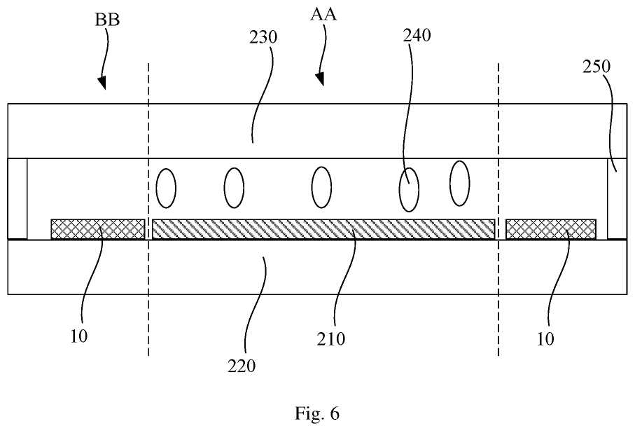

In order to solve the above problems, referring to FIGS. 1 to 7, a new circuit for gate driving 100 is proposed in the present disclosure. In one embodiment of the present disclosure, the circuit for gate driving 100 includes:

N row-driving circuits 10 arranged in cascade on an array substrate, each row-driving circuit 10 including a signal input end, a pull-up control signal end and an output end for gate driving signal;

N auxiliary circuits 20, each of which is arranged corresponding to each of the row-driving circuits 10, and each of the auxiliary circuits 20 includes an input end, a controlled end and an output end. The Nth auxiliary circuit 20 receives the (N−1)th gate driving signal at the input end, the controlled end of the Nth auxiliary circuit 20 is connected with the pull-up control signal end of the Nth row-driving circuit 10, and the output end of the Nth auxiliary circuit 20 is connected with the output end for gate driving signal of the row-driving circuits 10.

the Nth row-driving circuit 10 is configured to output an Nth gate driving signal in response that the signal input end receives the gate driving signal (gate opending signal) output by the (N−1)th row-driving circuit 10, and to control the Nth sub pixel to charge.

The Nth auxiliary circuit 20 is configured to control the sub pixels at the Nth row to charge, in response that both the (N−1)th gate driving signal from the input end and the (N−1)th pull-up control signal from the controlled end are at high level.

In the present embodiment, the display panel 200 has a display area AA and a display area BB, each row-driving circuit 10 is arranged in the display area BB. And the display area BB can be arranged on one side or both sides according to the size of the display panel 200. In the present embodiment, the display area BB is arranged at two sides. In order to improve the charging efficiency of the display panel 200, and to quickly complete the charging of pixels, each row-driving circuit 10 can enable the precharge function, so that the signal of the row-driving circuit 10 at coming rows is initiated in advance, and change the pixel voltage of that row to the target voltage of the current frame in advance.

Each row-driving circuit 10 is arranged in cascade, and each row-driving circuit 10 is usually provided with a charging unit, an output unit and the like. The charging unit receives the gate driving signal output from the row-driving circuit 10 at the previous row and outputs a pull-up control signal. When the output unit receives the pull-up control signal, the output unit receives the pull-up control signal, and outputs a high-level timing signal as the gate driving signal of the current sub-pixel on condition that the timing signal is at a high-level. In the entire row-driving circuits 10, the input signal of the first stage row-driving circuit 10 is the frame start signal STV, while the input signals of the second to Nth row-driving circuits 10 are provided by the output signals of the previous row-driving circuit 10. Each row-driving circuit 10 is usually provided with a capacitor, which will output a pull-up control signal before it is conducted, in order to precharge this capacitor. Until the timing signal is at a high level and the row-driving circuit 10 is turned on, the sub-pixel thin film transistors of the corresponding row is driven to turn on and control the sub pixels at the Nth row to be charged.

A controlled end of each auxiliary circuit 20 is connected with a pull-up control signal end of the previous row-driving circuit 10. When the pull-up control signal output from the pull-up control signal end of the previous row-driving circuit 10 is at a high level, the auxiliary circuit 20 is turned on and controls the Nth sub-pixel to charge.

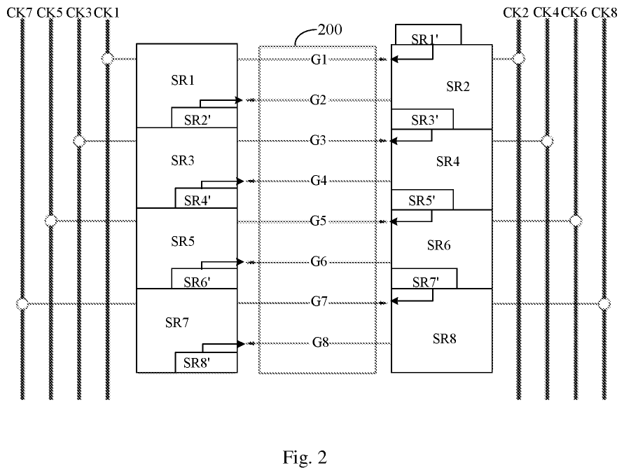

Specifically, FIG. 2 is referred to. The embodiment takes the Nth row of sub pixels as an example, where N is greater than or equal to 2. Description is provided given to the conditions of the change of data voltage of the Nth row-driving circuit 10, the Nth auxiliary circuit 20, and of sub pixels at the Nth row, as well as various timing signals and data signal output diagrams. In an embodiment, the number of N is 8, and the 8 auxiliary circuits are respectively marked as SR1′, SR2′, SR3′, SR4′, SR5′, SR6′, SR7′, and SR8′. Eight row-driving circuits are labeled as SR1, SR2, SR3, SR4, SR5, SR6, SR7 and SR8 respectively. The 8 auxiliary circuit and the 8 row-driving circuit are connected to the display panel 200 through scanning lines G1 to G8, respectively.

In the row-driving circuit 10 corresponding to the Nth row of sub-pixels, the signal input end of the Nth row-driving circuit 10 receives the gate driving signal output from the (N−1)th row-driving circuit 10, the input end of the Nth auxiliary circuit 20 receives the (N−1)th gate driving signal G(n−1), and the controlled end receives the pull-up control signal Q (output by the pull-up control signal end of the (N−1)th stage row-driving circuit 10. The Nth auxiliary circuit 20 and Nth row-driving circuit 10 are both high level triggered, which means that they work at the high level, while stop work at the low level. Generally, the high-level pull-up control signals of the Nth row-driving circuit 10 and the Nth row-driving circuit 10 differs in half a cycle of a waveforms. After the high-level pull-up control signal of the Nth row-driving circuit 10 is maintained for half a cycle, the pull-up control signal of the Nth row-driving circuit 10 jumps to the high level.

While the (N−1)th row-driving circuit 10 is charging the (N−1)th sub-pixels, the gate driving signal g N−1 of the (N−1)th row-driving circuit 10 is at the high level, which triggers the Nth row-driving circuit 10 to work. When the timing control signal Ck(n) of the Nth row-driving circuit 10 is at the high level, it outputs a high-level gate driving signal to the sub-pixels of the Nth row, thereby driving the Nth row of sub-pixels to start precharging. Before the (N−1)th row-driving circuit 10 charges the (N−1)th sub-pixels, the charging unit of the (N−1)th row-driving circuit 10 will output a pull-up control signal to the output unit of the Nth row-driving circuit 10 and to the controlled end of the Nth auxiliary circuit 20, which would be turned on when the (N−1)th row-driving circuit 10 outputs a gate driving signal at the high-level. And the Nth auxiliary circuit 20 further controls the sub pixels at the Nth row to charge. That is, when the (N−1)th row-driving circuit 10 charges the (N−1)th row sub-pixels, the Nth auxiliary circuit 20 will control the sub pixels at the Nth rows to charge in advance, thus increasing the charging time of the sub pixels at the Nth rows, ensuring the charging uniformity of the whole display panel 200, and improving the uniformity of panel brightness.

When the gate driving signal of the (N−1)th row-driving circuit 10 is output to the charging unit of the Nth row-driving circuit 10 and the charging unit outputs a high-level pull-up control signal to trigger the output unit to be turned on, the timing signal is at a high level at the Nth row, and then the timing signal is used as the gate driving signal to control the sub-pixels to turn on and charge at the Nth row. The (N−1)th gate driving signal is still at a high level, the Nth auxiliary circuit 20 and the Nth row-driving circuit 10 will simultaneously output gate driving signals to the sub pixels at the high-level at the Nth row. The Nth row-driving circuit 10 can control these sub-pixels at the adjacent end to charge, while the Nth auxiliary circuit 20 can control these sub-pixels at the distant end to compensate for non fully charged voltage by the gate driving signals. which are caused by long scanning lines or in staggered single drive architecture.

It can be understood that in the display panel 200, since the storage capacity of the sub-pixel is fixed, the sum of the pre-charging and charging is equal to the total capacity. The voltage at both ends of the storage capacity of the sub-pixel will remain stable and unchanged when it is charged to the maximum value of its capacity. It means that, the auxiliary circuit 20 can compensate the charging voltage consumed by the sub-pixels with long traces and improve the charging saturation rate of these sub-pixels, while in the sub-pixels with short traces, the voltage compensation by the auxiliary circuit 20 can improve the charging rate of these sub-pixels without affecting the charging saturation rate.

By N row-driving circuits 10 in cascade and auxiliary circuits corresponding to each of the row-driving circuits 10, Nth signal for gate driving is output when the input end of the Nth row-driving circuit 10 receives the row-driving signal output from the (N−1)th row-driving circuit 10. That is, when N−1 signal for gate driving received by the input end of the auxiliary circuit 20, and N−1 pull-up control signal received by the controlled end of the auxiliary circuit 20 are both at high levels, the circuit for gate driving at Nth is controlled for the sub pixels at the Nth row to charge, and for the Nth circuit for gate driving to charge on the array substrate. According to the disclosure, the N auxiliary circuit 20 and the N row-driving circuits 10 charge the sub-pixels of a same row simultaneously, thereby compensating the voltage which induces uneven charging of sub-pixels between the near-end and far-end caused by the uneven wiring of the display panel 200 during pixel charging of sub-pixels at the Nth row. The present disclosure charges a sub pixel at a same level simultaneously by the N auxiliary circuits and N row-driving circuits in cascade on the array substrate. The present disclosure compensates the non-fully charged sub pixels induced by a long wiring of the gate driving signal output from previous row-driving circuit to reach the next circuit. This problem is further induced by even wiring between the sub pixels at the adjacent end and at the distant end. And it is also induced by that multiple row-driving circuits on the array substrate are arranged at two sides of the display panel. The waveform of the gate driving signal is designed without affecting the N row-driving circuits 10 by introducing the the N auxiliary circuits 20, to ensure that each sub pixel at each row is charged to saturation, which is beneficial to the same charging effect and consistent brightness of each sub pixel. The present disclosure resolves the difference in charging saturation among sub-pixels or the pour saturation of the whole display panel 200. The unintended gray scale and dark lines have been solved, and the picture quality of the display device has improved.

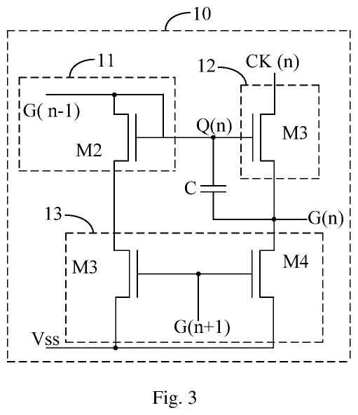

Referring to FIG. 3, in an embodiment, each auxiliary circuit 20 comprises a first active switch M1, a controlled end of the first active switch M1 is the controlled end of the auxiliary circuit, an input end of the first active switch M1 is the input end of the auxiliary circuit 20, and the output end of the first active switch M1 is the output end of the auxiliary circuit 20.

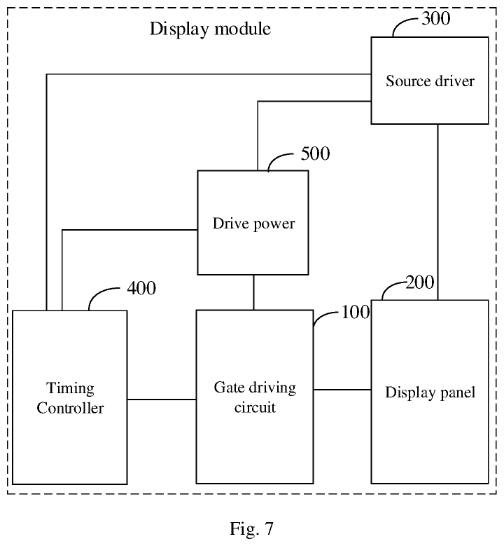

In this embodiment, the first active switch M1 can be an N-type thin film transistor. They are turned on at a high level. In this embodiment, the first active switch M1 is controlled based on the pull-up control signal of the (N−1)th row-driving circuit 10. When the pull-up control signal of the (N−1)th row-driving circuit 10 is at a high level, the first active switch M1 is turned on and outputs the (N−1)th gate driving signal to the sub pixels at the Nth row, and drives these sub pixels to charge. Referring to FIG. 7, the waveform of G(n) is an uncompensated gate driving signal, and the waveform of G(n)′ is a compensated gate driving signal. It can be seen that before the Nth row-driving circuit 10 outputs the gate driving signal to the sub pixels at the Nth row and drives the sub pixels at the Nth row, that is, while the (N−1)th row-driving circuit 10 controls the sub pixels at the (N−1)th row to charge, the Nth auxiliary circuit 20 is driven to charge the sub pixels at the Nth row in advance, so that a gate driving signal can be enhanced to the sub pixels at the Nth row, and the voltage time applied to the gate end of the sub pixels at the Nth row increases. The driving capacity for these sub pixels are enhanced, increasing the charging rate and saturation rate of the sub pixels.

Referring to FIG. 2, in an embodiment, each row-driving circuit 10 comprises a charge circuit 11, a reset circuit 12 and an output circuit 13, wherein an input end of the charge circuit 11 is the input end of the row-driving circuit 10, an output end of the charging circuit 11 is the pull-up control signal end of the row-driving circuit 10 and is connected with a controlled end of the output circuit 13, the input end of the output circuit 13 receives a current timing signal, and the row-driving circuit 10 outputs the gate driving signal at the output end of the output circuit 13.

In this embodiment, the row-driving circuit 10 may have a 4T1C cell structure (i.e., four thin film transistors and a capacitor C) or an 8T1C cell structure (i.e., eight thin film transistors and a capacitor C). In this embodiment, the 4T1C cell structure can be selected as an example. Specifically, the charging circuit 11 includes a second active switch M1 whose input and controlled ends are the input ends of the charging circuit 11, and whose output end is the output end of the charging circuit 11. The reset circuit 12 includes a third active switch M3 and a fourth active switch M4, the controlled ends of which are connected to the gate driving signal output by the (N+1)th row-driving circuit 10, and the input ends of which are respectively connected to the gate closing signal. An output end of the third active switch M3 is connected with the pull-up control signal end, and an output end of the fourth active switch M4 is connected with the output end of the gate driving signal. The output circuit 13 comprises a fifth active switch M5, a controlled end of the fifth active switch M5 is the controlled end of the output circuit 13, an input end of the fifth active switch M5 is the input end of the output circuit 13, and the output end of the fifth active switch M5 is the output end of the output circuit 13.

Each active switch can include thin film transistors, and more specifically, it can be N-type thin film transistors with high-level conduction. In some embodiments, each row-driving circuit 10 further includes a pull-down circuit (not shown) and a pull-down driving circuit (not shown). The pull-down circuit is configured to output a reset signal to the output end and the controlled end of the output circuit 13 to control the output circuit 13 to stop working.

An input end of the output circuit 13 is connected with a pull-up control signal end output from the charging circuit 11, and is mainly configured to output a gate driving signal G(n) according to the pull-up control signal Q(n). The reset circuit 12 is respectively connected to the controlled end of the output circuit 13 and the output end of the gate driving signal, and pulls down the pull-up control signal Q(n) and the line scanning signal G(n) to a low level after scanning pixel circuit of the current line. The row-driving circuit 10 may be provided with a bootstrap capacitor, the first pole of which is connected to the pull-up control signal end, and the second pole of which is connected to the gate driving signal output end of the current row-driving circuit 10. The bootstrap capacitor C is configured to maintain the voltage between the output circuits 13 and stabilize the output from the output circuits 13.

Before the gate driving signal of the (N−1)th stage is output, the timing signal Ck(n) is at a low level, and the level of the pull-up control signal end is also at a low level. No signal is output by the output circuit 13. When the gate driving signal of the (N−1)th stage is output, the level of the pull-up control signal end is at high level, and Ck(n) is currently low. The signal outputs from the output end of the output circuit 13 is low.

When the gate driving signal of the (N−1)th stage is output, the pull-up control signal Q(n) received from the pull-up control signal end is at high level, and Ck(n) is currently at the high level. The output end of the output circuit 13 outputs a gate driving signal at high-level to turn on the thin film transistors corresponding to the sub pixels at the Nth row, thereby driving the Nth row of sub pixels to charge or precharge.

Since the pull-up control signal output from the Nth pull-up control signal end controls the (N+1)th auxiliary circuit 20 to work, when the gate driving signal at the (N−1)th row is output, the level of the pull-up control signal end is at a high level, and the N+1th auxiliary circuit 20 turns on when it receives the high-level pull-up control signal. When the Nth gate driving signal is at a high level, it will be regarded as the gate driving signal for the sub pixels at the (N+1)th row to be conducted and charge. The gate driving signal of the Nth row-driving circuit 10 is also the input signal of the (N+1)th row-driving circuit 10, so the N+1th row-driving circuit 10 will also be precharged during the period when the output circuit 13 outputs the gate driving signal. After the Nth auxiliary circuit 20 charges the Nth sub pixel for half a cycle, The (N+1)th auxiliary circuit 20 and the N+1 th row-driving circuit 10 respectively and simultaneously control the N+1th sub-pixels at the distant end and the adjacent end, thereby improving the conduction rate of the thin film transistors in the sub-pixels at the N+1th row, and further improving the charging rate and charging saturation rate.

The (N+1)th row-driving circuit 10 controls the active switch in the reset circuit 12 to turn on after outputting the high-level gate driving signal, and then outputs the pull-down control signal with a low-level to the controlled end of the output circuit 13 and the output gate driving signal (gate off signal) with a low level to the sub pixels at the (N+1)th row to control the thin film transistor in these sub pixels to turn off.

The disclosure also provides a display module.

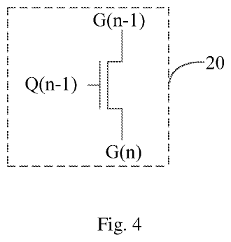

Referring to FIG. 4, the display module includes a display panel 200 having two opposite sides and including a pixel array 210, and

the circuit 100 of driving a gate described above. The circuit 100 includes N row-driving circuits 10 arranged in cascade and auxiliary circuits 20 arranged corresponding to each row-driving circuit 10, the N row-driving circuits 10 and N auxiliary circuits 20 are arranged at a side of the display panel.

In this embodiment, the display panel 200 may be an OLED (organic light-emitting diode) display panel 200 or a TFT-LCD (thin film transistor liquid crystal display) display panel 200.

In the present embodiment, the display module further includes a source driving circuit 300 and a plurality of data lines, and a plurality of output ends of the source driving circuit 300 are connected to input ends of the pixel array 210 in one-to-one correspondence via a plurality of data lines.

The pixel array 210 of the display panel 200 is composed of a plurality of sub-pixels, and three sub-pixels (red, green and blue) constitute one pixel. The gate ends of the sub-pixels located in the same row are connected with the primary row-driving circuit 10 through scanning lines, and the sources of the sub-pixels located in the same column are connected with the source driving circuit 300 through data lines.

In some embodiments, the display device is further provided with a timing controller 400 and a drive power 500. The source driving circuit 300 is used for inputting the source driving circuit 300 of the data signal. The source driving circuit 300 is installed on the driving board PCBA and connected with the timing controller 400. A plurality of output ends of the source driving circuit 300 are connected with corresponding data lines of the pixel array 210 respectively. The timing controller 400 receives data signals, control signals and clock signals output by an external control circuit, such as a control system SOC of a TV set, and converts them into data signals, control signals and clock signals suitable for each circuit for gate driving 100 and source driving circuit 300. The source driving circuit 300 outputs the data signals to corresponding pixels through data lines to realize image display on the display panel 200. There are a plurality of source driving circuits 300, which can be set according to the size of the display panel 200. Description is provided taking two source driving circuits 300 as an example. A drive power 500, the output end of which is connected with the circuit for gate driving 100 and the source driving circuit 300. The drive power 500 integrates a plurality of DC-DC conversion circuits with different circuit functions, and each conversion circuit outputs a different voltage value. The input voltage of the drive power 40 is generally 5V or 12V, and the output voltage includes the working voltage DVDD provided to the timing controller 400 and the working voltage provided to the row-driving circuit 10.

Referring to FIGS. 1 to 7, in an embodiment, the display panel 200 has a first side and a second side which are oppositely arranged.

The N row-driving circuits 10 and the N auxiliary circuits 20 are arranged on two sides of the display panel 200.

In this embodiment, the row-driving circuits 10 arranged on opposite sides of the display panel 200 can alternately control each row of sub-pixels to be conducted. For example, the row-driving circuits 10 arranged on one side of the display panel 200 control odd-numbered rows of sub-pixels, while row-driving circuits 10 arranged on the other side of the display panel 200 control even-numbered rows of sub-pixels, so as to realize single drive in a staggered mode.

Further, in the above single drive, the display panel 200 includes:

a pixel array 210, which further includes a plurality of sub-pixels at odd-numbered rows and a plurality of sub-pixels at even-numbered rows.

the sub-pixels at each odd-numbered row is connected with an row-driving circuit 10 arranged on the first side, and the sub-pixels at each odd-numbered row is connected with an auxiliary circuit 20 arranged on the second side.

The sub-pixels of each even-numbered row are connected with an row-driving circuit 10 arranged on the second side, and the sub-pixels of each even-numbered row are connected with an auxiliary circuit 20 arranged on the first side.

In this embodiment, the row-driving circuit 10 and the auxiliary circuit 20 are arranged on both sides of the display panel 200. The row-driving circuit 10 arranged on the first side can drive odd-numbered sub-pixels to work, while the row-driving circuit 10 arranged on the second side can work even-numbered sub-pixels. Auxiliary circuits 20 of odd rows are arranged on the second side and auxiliary circuits 20 of even rows are arranged on the first side. The row-driving circuit 10 and the auxiliary circuits 20 driving the same row of sub-pixels are respectively arranged on both sides of display panel 200. The row-driving circuit 10 can drive the sub-pixels at the adjacent end to charge, and the auxiliary circuit 20 located in the same row can drive the sub-pixels at the distant end to charge before the row-driving circuit 10, and then drive the sub-pixels in the same row together with the row-driving circuit 10 to charge. The driving current can flow from both ends to the middle area and drive the whole row of sub-pixels to charge. Since the auxiliary circuit 20 can charge the sub-pixels at distant end, the problem of insufficient driving force for these sub-pixels by the row-driving circuit 10 located at the adjacent end can be compensated, and each sub-pixel can be charged with saturation. It can be understood that the row-driving circuit 10 can be made narrower in typesetting (twice as high as it can be used), which is more suitable for narrow frame panels. Furthermore, with the row-driving circuit 10 and the auxiliary circuit 20, a new type of dual driving can be formed, and the driving force for sub-pixels can be enhanced.

In an embodiment, the display panel 200 has a first side and a second side which are oppositely arranged.

the N row-driving circuits 10 are all arranged on the first side of the display panel, and

the N auxiliary circuits 20 are all arranged on the second side of the display panel.

Further, the display panel 200 includes:

a pixel array 210, which further includes: a plurality of sub-pixels in N rows.

Sub pixels in each row are connected with a row-driving circuit 10 and an auxiliary circuit 20 on the array substrate.

The row-driving circuit 10 is disposed on one side of the display panel 200, and controls the sub-pixels to be turned on row by row to realize single driving. The auxiliary circuit 20 is arranged on the other side, that is, the row-driving circuit 10 and the auxiliary circuit 20 are respectively arranged on both sides of the display panel 200. The row-driving circuit 10 and the auxiliary circuit 20 driving the same row of sub-pixels are respectively arranged on both sides of the display panel 200, thus driving the entire row of sub-pixels to charge. Driving force can be compensated of the row-driving circuit 10 at the adjacent end to drive the sub pixels at the distant end. Every sub pixel is ensured to be charged with saturation.

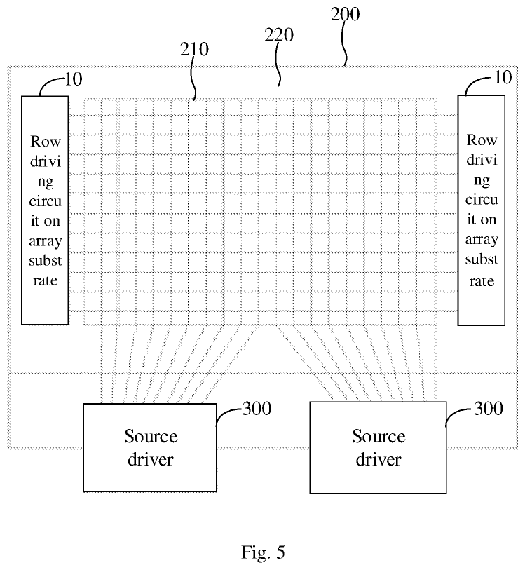

Referring to FIG. 5, in an embodiment, the display panel 200 further includes:

a first substrate 220 having a display area AA and its peripheral area: non-display area BB. The pixel array 210 is disposed on the first substrate 220 and located in the AA area of the display area. The N row-driving circuits 10 in cascade and auxiliary circuits 20 are arranged on the first substrate 220 and located in its peripheral area;

a second substrate 230 disposed opposite to the first substrate 220;

a liquid crystal layer 240 disposed between the first substrate 220 and the second substrate. The liquid crystal layer 240 includes a plurality of liquid crystal molecules, and the pixel array 210 is used for controlling the actions of the liquid crystal molecules.

In this embodiment, the first substrate 220 and the second substrate are generally transparent substrates such as glass substrates or plastic substrates. The second substrate is opposite to the first substrate 220, and corresponding circuits can be provided between the first substrate 220 and the second substrate. The first substrate 220 is an array substrate, the second substrate is a color film substrate. The first substrate 220 and the second substrate can be flexible transparent substrates.

The pixel array 210 is disposed on the first substrate 220 and located in the display area AA. Under the driving control of the row-driving circuit 10, the pixel array 210 can generate control signals to control the display on the display panel 200.

The row-driving circuit 10 is disposed on the first substrate 220 and located in the display area BB. Accordingly, the row-driving circuit 10 can be isolated from the liquid crystal layer 240, so that liquid crystal free areas are formed between the row-driving circuit 10 and the second substrate 230.

It can be understood that in the above embodiment, the display panel 200 further includes a frame sealant 250 disposed in the display area BB between the first substrate 220 and the second substrate 230. The frame sealant 250 also surrounds the liquid crystal layer 240, and the row-driving circuit 10 is located between the frame sealant 250 and the display area AA. The frame sealant 250 can be coated on the first substrate 220 or the second substrate 230 by using sealant to connect the first substrate 220 and the second substrate 230, enabling the assembly of the display panel 200. Particularly, the pixel array 210 is a pixel array 210 with a half source driving (HSD) architecture.

Referring to FIG. 4, in an optional embodiment, the pixel array 210 includes a plurality of sub-pixels, each of which includes an active switch (thin film transistor) and a pixel capacitor. The gate of the active switch T is electrically connected with the scanning line corresponding to the sub pixels, the source of the active switch is electrically connected with the data line corresponding to the pixel circuit, and the drain of the active switch is electrically connected with the pixel capacitor of the sub-pixel. The pixel array 210 may further includes a pixel capacitor array connected to an array of the active switching element.

The display panel 200 is composed of a plurality of pixels, and each pixel is composed of three sub-pixels including red, green and blue. Each sub-pixel circuit structure is generally provided with a thin film transistor and a pixel capacitor. The gate of the thin film transistor is connected with the gate driver through a scanning line, the source of the thin film transistor is connected with the source driver circuit 300 through a data line, and the drain of the thin film transistor is connected with one end of the pixel capacitor. A plurality of thin film transistors constitute the thin film transistor array (not shown). Thin film transistors 31 in the same column are connected to the source driver circuit 300 through a data line, and thin film transistors in the same row are connected to the gate driver through a scanning line, thus forming an array of thin film transistor. The row-driving circuit 10 supplies voltages to the gates of the plurality of thin film transistors. These thin film transistors can be a-Si (non-silicon) thin film transistors or Poly-Si (polysilicon) thin film transistors, in which the Poly-Si thin film transistors can be formed by LTPS (low temperature poly-silicon) and other technologies.

The present disclosure also provides a display device, which includes the circuit for gate driving or the display module described above. The detailed structure of the display module and the circuit for gate driving can be referred to the descriptions above, and will not be repeated here. It can be understood that since the above-mentioned display module and circuit for gate driving are used in the display device of the present disclosure, embodiments of the display device of the present disclosure include all technical solutions of all embodiments of the above-mentioned display module and circuit for gate driving. They share the same technical effects, which will not described in detail herein.

The above is only the preferred embodiment of the present disclosure and is not therefore limiting the scope of the present disclosure. Any equivalent modification made by using the contents of the present specification and drawings, or directly or indirectly applied in other related technical fields, shall be included in the protection scope of the present disclosure.

What is claimed is:

1. A circuit for gate driving, comprising:
N row-driving circuits arranged in cascade on an array substrate, wherein each row-driving circuit comprises a signal input end, a pull-up control signal end and an output end for gate driving signal; an Nth row-driving circuit is configured to output an Nth gate driving signal in response that the signal input end receives an (N−1)th gate driving signal output from the (N−1)th row-driving circuit, and to control an Nth sub pixel to charge;
N auxiliary circuits, wherein each auxiliary circuit is arranged corresponding to one row-driving circuit on the array substrate, and each auxiliary circuit comprises an input end, a controlled end and an output end, wherein
an Nth auxiliary circuit is for receiving the (N−1)th gate driving signal at the input end, the controlled end of the Nth auxiliary circuit is connected with the pull-up control signal end of the Nth row-driving circuit, and the output end of the Nth auxiliary circuit is connected with the output end for gate driving signal of the Nth row-driving circuit;
the Nth auxiliary circuit is configured to control the sub pixels at the Nth row to charge, in response that both the (N−1)th gate driving signal from the input end and the (N−1)th pull-up control signal from the controlled end are at high level, wherein N≥2.

2. The circuit according to claim 1, wherein,
each auxiliary circuit comprises a first active switch, wherein a controlled end of the first active switch is the controlled end of the auxiliary circuit, an input end of the first active switch is the input end of the auxiliary circuit, and the output end of the first active switch is the output end of the auxiliary circuit.

3. The circuit according to claim 1, wherein,
each row-driving circuit comprises a charge circuit, a reset circuit and an output circuit, wherein an input end of the charge circuit is the signal input end of the row-driving circuit,
an output end of the charging circuit is the pull-up control signal end of the row-driving circuit and is connected with a controlled end of the output circuit,
an input end of the output circuit is for receiving a current timing signal, and an output end of the output circuit is the output end for gate driving signal of the row-driving circuit.

4. A display module, comprising:
a display panel; and
a circuit for gate driving, wherein the circuit comprises N row-driving circuits arranged in cascade and auxiliary circuits arranged corresponding to each row-driving circuit, the N row-driving circuits and N auxiliary circuits are arranged at opposite sides of the display panel, wherein:
each row-driving circuit comprises a signal input end, a pull-up control signal end and an output end for gate driving signal; an Nth row-driving circuit is configured to output an Nth gate driving signal in response that the signal input end receives an (N−1)th gate driving signal output from the (N−1)th row-driving circuit, and to control an Nth sub pixel to charge;
each auxiliary circuit is arranged corresponding to one row-driving circuit on the array substrate, and each auxiliary circuit comprises an input end, a controlled end and an output end,
an Nth auxiliary circuit is for receiving the (N−1)th gate driving signal at the input end, the controlled end of the Nth auxiliary circuit is connected with the pull-up control signal end of the Nth row-driving circuit, and the output end of the Nth auxiliary circuit is connected with the output end for gate driving signal of the Nth row-driving circuit;
the Nth auxiliary circuit is configured to control the sub pixels at the Nth row to charge, in response that both the (N−1)th gate driving signal from the input end and the (N−1)th pull-up control signal from the controlled end are at high level, wherein N≥2.

5. The display module according to claim 4, wherein
each auxiliary circuit comprises a first active switch, wherein a controlled end of the first active switch is the controlled end of the auxiliary circuit, an input end of the first active switch is the input end of the auxiliary circuit, and the output end of the first active switch is the output end of the auxiliary circuit.

6. The display module according to claim 4, wherein
each row-driving circuit comprises a charge circuit, a reset circuit and an output circuit, wherein an input end of the charge circuit is the signal input end of the row-driving circuit,
an output end of the charging circuit is the pull-up control signal end of the row-driving circuit and is connected with a controlled end of the output circuit,
an input end of the output circuit is for receiving a current timing signal, and an output end of the output circuit is the output end for gate driving signal of the row-driving circuit.

7. The display module according to claim 4, wherein
the display panel has a first side and a second side which are oppositely arranged;
the N row-driving circuits and the N auxiliary circuits are arranged on the first and second sides of the display panel.

8. The display module according to claim 7, wherein the display panel comprises:
a pixel array comprising a plurality of sub-pixels at odd-numbered rows and a plurality of sub-pixels at even-numbered rows, wherein,
the sub-pixels at each odd-numbered row is connected with the row-driving circuits arranged on the first side, and the sub-pixels at each odd-numbered row is connected with the auxiliary circuits arranged on the second side,
the sub-pixels of each even-numbered row are connected with the row-driving circuits arranged on the second side, and the sub-pixels of each even-numbered row are connected with the auxiliary circuits arranged on the first side.

9. The display module according to claim 4, wherein
the display panel has a first side and a second side which are oppositely arranged;
the N row-driving circuits are all arranged on the first side of the display panel, and
the N auxiliary circuits are all arranged on the second side of the display panel.

10. The display module according to claim 9, wherein the display panel comprises:
a pixel array comprising a plurality of sub-pixels arranged in N rows, wherein
sub pixels in each row are connected with one row-driving circuit and one auxiliary circuit on the array substrate.

11. The display module according to claim 4, further comprising a source driver and a plurality of data lines, wherein a plurality of output ends of the source driver are connected with the pixel array of the display panel through the plurality of data lines.

12. A display device, comprising a circuit for gate driving, wherein the circuit comprises:
N row-driving circuits arranged in cascade on an array substrate, wherein each row-driving circuit comprises a signal input end, a pull-up control signal end and an output end for gate driving signal; an Nth row-driving circuit is configured to output an Nth gate driving signal in response that the signal input end receives an (N−1)th gate driving signal output from the (N−1)th row-driving circuit, and to control an Nth sub pixel to charge;
N auxiliary circuits, wherein each auxiliary circuit is arranged corresponding to one row-driving circuit on the array substrate, and each auxiliary circuit comprises an input end, a controlled end and an output end, wherein
an Nth auxiliary circuit is for receiving the (N−1)th gate driving signal at the input end, the controlled end of the Nth auxiliary circuit is connected with the pull-up control signal end of the Nth row-driving circuit, and the output end of the Nth auxiliary circuit is connected with the output end for gate driving signal of the Nth row-driving circuit,
the Nth auxiliary circuit is configured to control the sub pixels at the Nth row to charge, in response that both the (N−1)th gate driving signal from the input end and the (N−1)th pull-up control signal from the controlled end are at high level, wherein N≥2.

13. The display device according to claim 12, wherein
each auxiliary circuit comprises a first active switch, wherein a controlled end of the first active switch is the controlled end of the auxiliary circuit, an input end of the first active switch is the input end of the auxiliary circuit, and the output end of the first active switch is the output end of the auxiliary circuit.

14. The display device according to claim 12, wherein
each row-driving circuit comprises a charge circuit, a reset circuit and an output circuit, wherein an input end of the charge circuit is the input end of the row-driving circuit,
an output end of the charging circuit is the pull-up control signal end of the row-driving circuit and is connected with a controlled end of the output circuit,
an input end of the output circuit is for receiving a current timing signal, and an output end of the output circuit is the output end for gate driving signal of the row-driving circuit.

15. The display device according to claim 12, wherein comprising:
a display panel; and
a circuit for gate driving, wherein the circuit comprises N row-driving circuits arranged in cascade and auxiliary circuits arranged corresponding to each row-driving circuit, the N row-driving circuits and N auxiliary circuits are arranged at opposite sides of the display panel.

16. The display device according to claim 15, wherein
the display panel has a first side and a second side which are oppositely arranged;
the N row-driving circuits and the N auxiliary circuits are arranged on the first and second sides of the display panel.

17. The display device according to claim 16, wherein
a pixel array comprising a plurality of sub-pixels at odd-numbered rows and a plurality of sub-pixels at even-numbered rows, wherein
the sub-pixels at each odd-numbered row is connected with the row-driving circuits arranged on the first side, and the sub-pixels at each odd-numbered row is connected with the auxiliary circuits arranged on the second side,
the sub-pixels of each even-numbered row are connected with the row-driving circuits arranged on the second side, and the sub-pixels of each even-numbered row are connected with the auxiliary circuits arranged on the first side.

18. The display device according to claim 12, wherein
the display panel has a first side and a second side which are oppositely arranged;
the N row-driving circuits are all arranged on the first side of the display panel, and
the N auxiliary circuits are all arranged on the second side of the display panel.

19. The display device according to claim 18, wherein
a pixel array comprising a plurality of sub-pixels arranged in N rows, wherein
sub pixels in each row are connected with one row-driving circuit and one auxiliary circuit on the array substrate.

20. The display device according to claim 12, wherein
the display device further comprises a source driver and a plurality of data lines, wherein a plurality of output ends of the source driver are connected with the pixel array of the display panel through the plurality of data lines.
